(19) United States
(12) Patent Application Publication
(10) Pub. No.: US 2013/0042976 A1
(43) Pub. Date: Feb. 21, 2013

(54) FILM ADHESIVES AND PROCESSES FOR BONDING COMPONENTS USING SAME

(71) Applicants: James A. Sanborn, Satellite Beach, FL (US); Robert J. Guinn, Melbourne, FL (US); Lisa O. Mitchell, Palm Bay, FL (US); Carlyn A. Smith, Orlando, FL (US); Louie M. Smith, Melbourne, FL (US)

(72) Inventors: James A. Sanborn, Satellite Beach, FL (US); Robert J. Guinn, Melbourne, FL (US); Lisa O. Mitchell, Palm Bay, FL (US); Carlyn A. Smith, Orlando, FL (US); Louie M. Smith, Melbourne, FL (US)

(73) Assignee: HARRIS CORPORATION, Melbourne, FL (US)

(21) Appl. No.: 13/213,557

(22) Filed: Aug. 19, 2011

(51) Int. Cl. C09J 163/00; B32B 37/12; B32B 37/15; B05D 5/10

(52) U.S. Cl. 156/330; 427/207.1

(57) ABSTRACT

Processes are provided for forming film adhesives (10). The processes include applying an adhesive (18), such as a Bisphenol A epoxy resin, to a membrane (14), and partially curing the adhesive (18). The resulting film adhesives (10) can be shipped and stored at room temperature. The film adhesives (10) can be used to bond components such as, but not limited to printed wireboards (11, 12) and other substrates. A structural bond between the components can be formed by fully curing the resin (18) while the resin (18) is in contact with at least one of the components.

### BACKGROUND OF THE INVENTION

1. Statement of the Technical Field

The inventive arrangements relate to film adhesives used to form structural bonds between components such as, but not limited to, printed wire boards, and to processes for forming film adhesives and bonding components using such adhesives.

2. Description of the Related Art

Film adhesives are widely used in the electronics and other industries to bond components together. A typical film adhesive comprises a membrane or substrate such as glass fibers, and an adhesive such as epoxy resin disposed on one or both sides of the membrane. The film adhesive, while in an uncured or partially-cured state, can be placed in contact with the components to be bonded. The film adhesive can then be fully cured so as to form a structural bond between the components.

Subjecting a film adhesive to room temperature for more than a limited time period, before the adhesive has been fully cured, can cause the bonding and other significant properties of the adhesive to degrade. Prior to use in the bonding process, therefore, film adhesives are usually shipped and stored at temperatures well below room temperature, e.g., 0° F. (−16° C.) or colder. The temperatures at which the film adhesive is shipped and stored need to be monitored carefully to help ensure that the integrity of the film adhesive has not been compromised due to exposure to excessive temperatures. If the film adhesive is exposed to temperatures in excess of the maximum allowable value due to loss of refrigeration or other factors, the film adhesive may need to be scrapped.

Conventional film adhesives typically have a limited workable life, e.g., six to eight hours, after being removed from cold storage. Moreover, the shelf life of conventional film adhesives can be relatively short, e.g., between six and twelve months.

The adhesive on a typical film adhesive can migrate, or flow horizontally, during the curing process. The tendency of the adhesive to migrate can increase when, as in a typical curing process, the adhesive is squeezed or pressed between the components being bonded. Thus, precautions need to be taken to ensure that the adhesive does not migrate into areas on the bonded components that cannot tolerate exposure to the resin. For example, the film adhesive may need to be trimmed back from such areas by a substantial amount, thereby lessening the surface area of the film adhesive and lowering the strength of the resulting bond formed by the film adhesive.

Conventional film adhesives can be deficient when used to bond components having substantially different coefficients of thermal expansion. In particular, the bond formed by a film adhesive can crack or degrade after repeated thermal cycles in which one of the bonded components expands or contracts substantially more than the other bonded component. To avoid this problem, film adhesives specially formulated for such applications may need to be used when bonding components with substantially different thermal expansion characteristics.

Conventional film adhesives can be relatively expensive. Also, because most film adhesives are not off-the-shelf items, the lead time for procuring film adhesives can be long, e.g., several months or more.

### SUMMARY OF THE INVENTION

Processes are provided for forming film adhesives. The processes include applying an adhesive to a membrane, and partially curing the adhesive. The resulting film adhesives can be shipped and stored at room temperature.

A process for bonding a first component to a second component comprises positioning on the first component a membrane having disposed thereon a partially cured bisphenol A epoxy resin. The positioning facilitates contact of the resin with the first component. The process also comprises positioning the second component so that it is also in contact with said resin, and further curing the resin to form a structural bond between the first and second components. The bisphenol A epoxy resin is adjusted to have a viscosity less than approximately 500 centipoise prior to the partial curing step.

A process for bonding a first component to a second component comprises providing a membrane; providing a bisphenol A epoxy resin having a viscosity less than approximately 500 centipoise; and applying the resin to the membrane. The process further comprises partially curing the resin; placing the partially-cured resin and/or the membrane in contact with the first and second components; and further curing the resin to form a structural bond between the first and second components.

A process for forming film adhesives comprises providing a membrane; providing a bisphenol A epoxy resin having a viscosity less than approximately 500 centipoise; applying the resin to the membrane; and partially curing the resin.

### BRIEF DESCRIPTION OF THE DRAWINGS

Embodiments will be described with reference to the following drawing figures, in which like numerals represent like items throughout the figures and in which:

FIG. 1 is a partially-exploded, diagrammatical side view of an embodiment of a film adhesive and a first and a second printed wireboard, before the wireboards are bonded using the film adhesive;

FIG. 2 is a diagrammatical side view of the film adhesive and the first and second wireboards shown in FIG. 1, after the first and second wireboards have been bonded using the film adhesive;

FIG. 3 is a perspective view of the film adhesive shown in FIGS. 1 and 2 in a partially-cured state, after the film adhesive has been cut and stamped to match the configuration of the first and second wireboards;

FIG. 4 is a flow diagram depicting a process for forming the film adhesive, and bonding the first and second wireboards shown in FIGS. 1-3

FIG. 5 is a diagrammatical illustration depicting the film adhesive and the first and second wireboards shown in FIGS. 1-3 being bonded in a final curing process conducted using an oven and a vacuum bag, with the oven depicted in a partial cutaway and the vacuum bag depicted in phantom.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

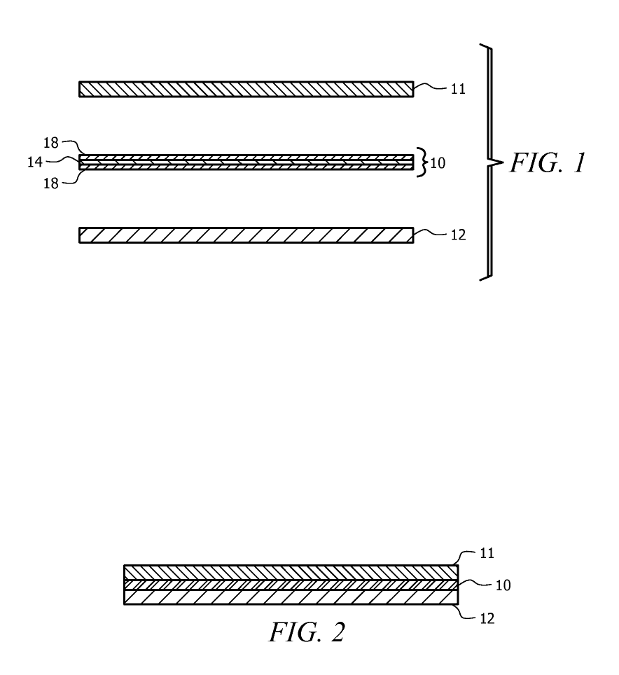

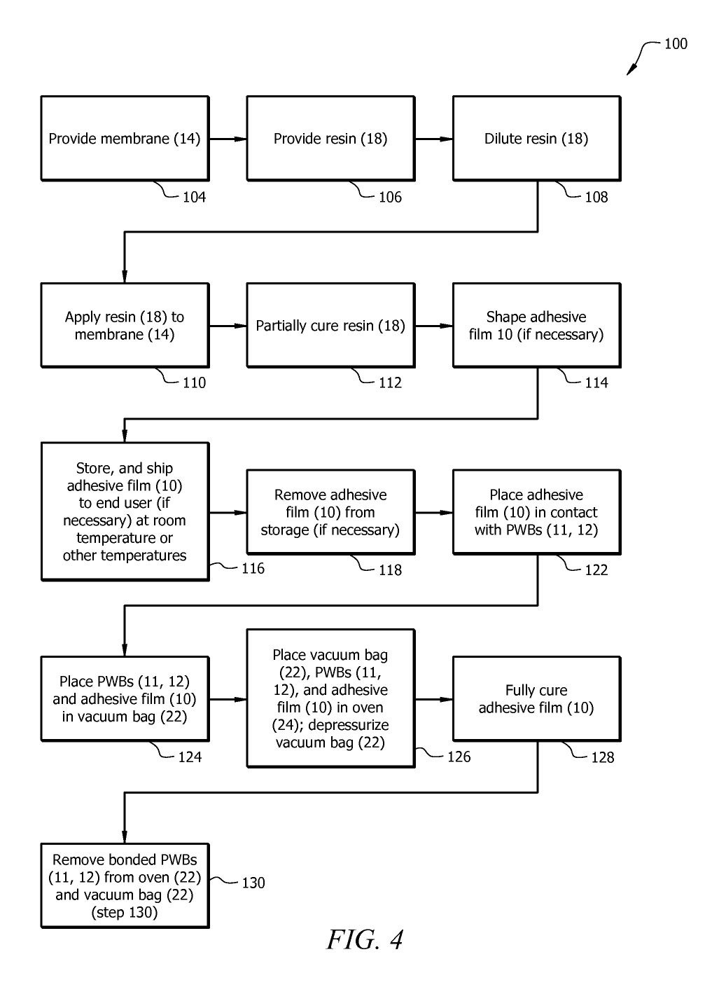

FIGS. 1-2 depict a film adhesive 10 for bonding two components to each other. For example, the film adhesive 10 can be used to bond a substrate, in the form of a first printed wire board (PWB) 11, to another substrate in the form of a second PWB 12, in accordance with the process 100 depicted in FIG. 4. The use of the film adhesive 10 to bond substrates in the form of the first and second PWBs 11, 12 is disclosed for exemplary purposes only. The film adhesive 10 can be used to bond other types of electronic and non-electronic components.

The process 100 includes providing a suitable membrane 14 (step 104 of FIG. 4). The material from which the membrane 14 is formed is dependent upon the specific requirements of the application in which the film adhesive 10 is to be used. For example, in the film adhesive 10 disclosed herein, the membrane 14 is formed from 3-mil (0.003-inch thick) glass fabric. The membrane 14 can be formed from aluminum, brass, a polyimide film such as DuPont KAPTON, or other suitable materials in alternative embodiments. The use of a 3-mil sheet is disclosed for exemplary purposes only; the membrane 14 can have a thickness other than 3 mils in alternative embodiments.

The process 100 also comprises providing an adhesive in the form of a bisphenol A epoxy resin, i.e., an epoxy resin comprising the chemical compound bisphenol A (step 106). The resin is denoted in the figures by the reference character 18. The resin 18 can be, for example, Y 663M-2 adhesive available from Elantas PDG.

The resin 18 can be modified to attain a viscosity of approximately 500 centipoise or lower (step 108). The resin 18 can be modified using a suitable non-reactive diluent such as LITE 2513HP from Cardolite Corporation. The viscosity of approximately 500 centipoise or lower permits complete wetting of the membrane 14.

The modified resin 18 can be applied to the membrane 14 by, for example, spraying, screening, or dipping (step 110). The resin 18 can be applied on both sides of the membrane 14, to form a layer of the resin 18 on each side of the membrane 14. Sufficient resin 18 can be applied so that each layer has a total thickness of approximately five to approximately ten mils when fully cured. The optimal thickness of the layers is application-dependent, and can vary with factors such as the types of resin 18 and membrane 14 being used, the resin content in the film adhesive 10, etc.

After being applied to the membrane 14, the resin 18 can be partially cured (step 112). For example, the resin 18 can be partially cured so as to attain a B-stage cure. The B-stage cure can be achieved by exposing the resin to room temperature, e.g., approximately 64° F. (18° C.) to approximately 73° F. (23° C.), without pressure being applied, for a minimum of approximately 30 minutes. The resin 18 can then be heated at ambient pressure until it attains a temperature of approximately 240° F. (116° C.), and this temperature can be held for approximately ten minutes. A limited reaction between the hardener and other compounds within the resin will cause the resin 18 to attain a partial or semi-cured state, or B stage, upon the completion of this partial curing cycle. The resin should not be exposed to the 240° F. temperature for longer than approximately ten minutes during the curing cycle, to avoid advancing the cure beyond the B stage.

A particular curing cycle for the resin 18 is specified for exemplary purposes only. The curing cycle necessary to attain a B-stage cure is application-dependent, and will vary with factors such as the specific types of resin 18 and membrane 14 being used, the thickness of the resin 18 and the membrane 14, etc.

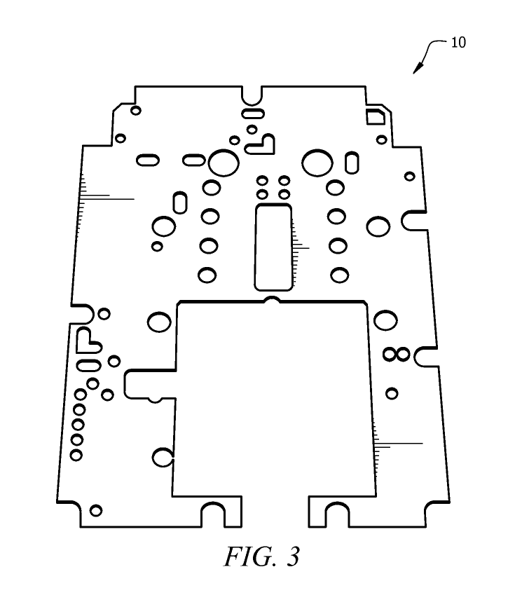

The membrane 14 and the partially-cured resin 18 form the film adhesive 10. If necessary, the film adhesive 10 at this point can be stamped, cut, or otherwise shaped for use in a particular application (step 114). For example, FIG. 3 depicts the film adhesive 10 after being shaped to match the configuration of the first and second PWBs 11, 12.

It has been found that the bisphenol A epoxy resin 18, when applied to the membrane 14 and then partially cured to attain a B-stage cure, is stable at room temperature. This quality permits the film adhesive 10 to be stored, and shipped to the end user (if necessary) at room temperature (step 116). Specifically, it is believed that the film adhesive 10 can be subjected, without time limitations, to temperatures in the range of approximately 32° F. (0° C.) to approximately 85° F. (29° C.) without experiencing any meaningful degradation in its bonding properties or other significant properties. The film adhesive 10, therefore, can safely be shipped and stored at temperatures within this range, in contrast to conventional film adhesives. Moreover, the film adhesive 10 does not require refrigeration prior to use, also in contrast to conventional film adhesives. The potential for the film adhesive 10 to degrade upon a loss of refrigeration during shipping and storage, therefore, is not present. Moreover, since cold storage is not required, there is no concern over the workable life of the film adhesive 10 after being removed from storage.

Moreover, it is believed that the film adhesive 10 has a relatively long storage life due to the relative stability of the partially-cured resin 18. In particular, the storage life of the film adhesive 10 is believed to be greater than two years at room temperature. This projected storage life is superior to the six to twelve-month storage-life of conventional film adhesives 20 when stored under refrigerated or frozen conditions.

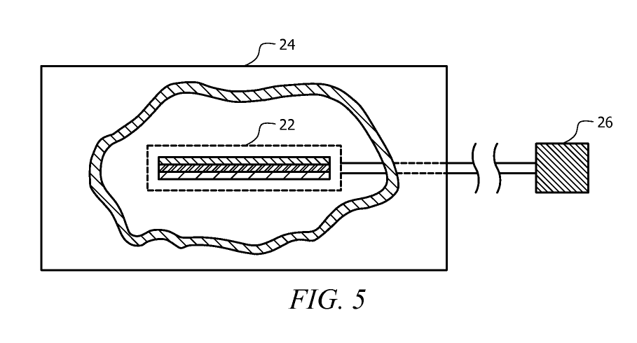

The process 100 further comprises using the film adhesive 10 to bond the first and second PWBs 11, 12, as follows. The film adhesive 10, after being removed from storage (if necessary) (step 118) can be placed on, or between the first and/or second PWBs 11, 12. The first and second PWBs 11, 12 can be aligned and brought together so that the film adhesive 10 is sandwiched therebetween, and the layers of resin 18 on the film adhesive 10 contact the first and second PWBs 11, 12 (step 122). The first and second PWBs 11, 12 can be immobilized from relative lateral movement by pins or other suitable means for restricting such movement. The resulting assembly made up of the first and second PWBs 11, 12 and the film adhesive 10 can then be placed in a vacuum bag 22, shown in FIG. 5 (step 124).

The vacuum bag 22, and the enclosed first and second PWBs 11, 12 and film adhesive 10, can be placed in an oven 24 (step 126). A vacuum source 26 can be connected to the vacuum bag 22 before or after the vacuum bag 22 and its contents are placed in the oven 24. A vacuum of approximately 29 inches of mercury can be drawn inside the vacuum bag 22. Mechanically-applied pressure, such as that applied by clamps or dead weights, can be used in lieu of vacuum bag 22 to obtain the pressure required for the bonding process.

The final curing process for the film adhesive 10 can be conducted at this point (step 128). The temperature in the oven 24 can be raised to approximately 250° F. (121° C.). The first and second PWBs 11, 12 and the film adhesive 10 can be subjected to this temperature for a minimum of four hours while in the de-pressurized vacuum bag 22, to effectuate final curing of the resin 18 in the film adhesive 10. The de-pressurized vacuum bag 24 exerts a substantially uniform clamping force of, for example, approximately 14.5 psi (99.3 kPa), which squeezes the first and second PWBs 11, 12 toward each other and thereby helps to form a uniform bond between the first and second PWBs 11, 12. The vacuum bag 22 and the enclosed assembly can be removed from the oven 24 upon completion of the four-hour curing period, and the first and second PWBs 11, 12, which are now bonded to each other through the film adhesive 10, can be removed from the vacuum bag 22 and routed to the next production operation (step 130). Upon reaching the fully cured state, the resin 18, in conjunction with the membrane 14, forms a structural bond between the first and second PWBs 11, 12 as depicted in FIG. 2.

The use of the oven 24 and the vacuum bag 22 to effectuate the final curing process for the resin 18 is disclosed for exemplary purposes only. The final curing process can be effectuated using other suitable means, such as an autoclave, in the alternative.

It has been found that the resin 18, when prepared and partially cured as discussed above, does not undergo any meaningful migration during the final curing process, even when being pressed or squeezed between two components such as the PWBs 11, 12. Because the resin 18 does not migrate, the film adhesive 10 does not need to be cut back or trimmed to avoid contamination of resin-intolerant areas on the first or second PWBs 11, 12 due to resin migration. Thus, the total surface area of the film adhesive 10 for a given application, and the strength of the resulting bond formed by the film adhesive 10, can be greater than might otherwise be possible. Moreover, the lack of any meaningful migration of the resin 18 can eliminate the need to optimize the manufacturing process for each new design to accommodate migration.

It is believed that variants of the film adhesive 10 can be used successfully to bond components having mismatched coefficients of thermal expansion (CTEs), e.g., CTEs that differ by approximately 14 parts per million or more per degree Centigrade. For example, a variant of the film adhesive 10 was used to bond a first substrate, formed from Aluminum, to a second substrate formed from Al2O3. The variant includes a membrane formed from DuPont KAPTON polyimide film. The resulting assembly was subjected to more than one-hundred thermal cycles in which the temperature of the assembly was cycled between approximately −40° F. (−40° C.) and approximately +212° F. (+100° C.), without a failure of the bond. The use of such a variant of the film adhesive 10 in such applications can thus eliminate the need for relatively expensive special adhesives specifically tailored to accommodate components with mismatched CTEs.

Moreover, the film adhesive 10 can be formed from relatively inexpensive and readily available materials. It is believed that the lead time needed to obtain the materials from which the film adhesive 10 is formed is a matter of days, as opposed to the weeks or months that may be needed to obtain some conventional film adhesives. Moreover, it is believed that the film adhesive 10 can be produced at about twenty percent of the cost of a conventional film adhesive of comparable capabilities.

In an alternative process to the process 100, the resin 18 can be applied directly to one or both of the components being bonded together, without the use of a membrane. The resin 18 can then be partially cured on the component. The component, with the partially-cured resin thereon, can be stored and/or shipped to the end user at room temperature. The component can be bonded to a second component by bringing the second component into contact with the partially-cured resin 18, and then further curing the resin 18 so that the resin 18 attains its fully cured state.

We claim:

1. A process for bonding a first component to a second component, comprising:
positioning on said first component a membrane having disposed thereon a partially cured bisphenol A epoxy resin, said positioning facilitating contact of said resin with said first component;
positioning the second component so that it is also in contact with said resin; and
further curing the resin to form a structural bond between the first and second components;
wherein said bisphenol A epoxy resin is selected to have a viscosity less than approximately 500 centipoise prior to said partial curing step.

2. The process according to claim 1, wherein said resin is disposed on first and second opposing planar faces of said membrane.

3. The process of claim 1, wherein the partially cured bisphenol A epoxy resin has a B-stage cure.

4. The process of claim 1, wherein positioning on said first component a membrane having disposed thereon a partially cured bisphenol A epoxy resin comprises positioning on said first component a membrane formed from a material selected from the group consisting of: glass; aluminum; brass; and polyimide film and having disposed thereon the partially cured bisphenol A epoxy resin.

5. The process of claim 1, wherein further curing the resin to form a structural bond between the first and second components comprises fully curing the resin.

6. A process for forming a film adhesive, comprising:
providing a membrane;
providing a bisphenol A epoxy resin having a viscosity less than approximately 500 centipoise;
applying the resin to the membrane; and
partially curing the resin.

7. The process of claim 6, wherein partially curing the resin comprises curing the resin to attain a B-stage cure in the resin.

8. The process of claim 6, wherein applying the resin to the membrane comprises spraying the resin onto the membrane.

9. The process of claim 6, wherein providing a membrane comprises providing a membrane formed from a material selected from the group consisting of: glass; aluminum; brass; and polyimide film.

10. The process of claim 6, wherein providing a bisphenol A epoxy resin having a viscosity less than approximately 500 centipoise comprises modifying the bisphenol A epoxy resin with a non-reactive diluent to attain a viscosity less than approximately 500 centipoise.

11. A process for bonding a first component to a second component, comprising:
providing a membrane;
providing a bisphenol A epoxy resin having a viscosity less than approximately 500 centipoise;
applying the resin to the first component;
partially curing the resin;
placing the partially-cured resin in contact with the second component; and
further curing the resin to form a structural bond between the first and second components.

12. The process of claim 11, further comprising applying the resin to the second component and partially curing the resin on the second component, wherein placing the partially-cured resin on the first component in contact with the second component comprises placing the partially-cured resin on the first component in contact with the partially-cured resin on the second component, and the process further comprises further curing the resin on the second component to further form the structural bond between the first and second components.

13. The process of claim 11, wherein partially curing the resin comprises curing the resin to attain a B-stage cure in the resin.
